(19) United States
(12) Patent Application Publication
(10) Pub. No.: US 2023/0228131 A1
(43) Pub. Date: Jul. 20, 2023

(54) METHOD FOR SECURELY DETECTING A CLOSED POSITION OF A MOVABLE PART OF A VEHICLE

(71) Applicant: Kiekert AG, Heiligenhaus (DE)

(72) Inventors: Holger SCHIFFER, Meerbusch (DE); Andreas ZIGANKI, Mettmann (DE); Thorsten BENDEL, Oberhausen (DE); Ömer INAN, Dorsten (DE); Manuel REUSCH, Düsseldorf (DE); Stefan EBERSOHN, Böblingen (DE)

(21) Appl. No.: 17/996,093

(22) PCT Filed: Apr. 1, 2021
(86) PCT No.: PCT/DE2021/100319

§ 371 Date: Oct. 20, 2022

(30) Foreign Application Priority Data
Apr. 21, 2020 (DE) 10 2020 110 769.2

(51) Int. Cl. E05B 81/72; E05B 81/70; E05B 81/56

(52) U.S. Cl. CPC E05B 81/72; E05B 81/70; E05B 81/56

(57) ABSTRACT

A method for detecting a closed position of a movable part of a vehicle, in particular an automatically operable vehicle, said method comprising the following steps: a control unit receives a first position signal from a first signal source as a first closure criterion which comprises at least one locking position of a vehicle lock for the movable part; the control unit adds a conditional test instruction to the received first position signal, wherein the conditional test instruction comprises checking for at least one second position signal as a second closure criterion after detecting the first position signal, wherein the first closure criterion is also satisfied; the control unit receives the second position signal from a second signal source as a second closure criterion, wherein the second signal source is different from the first signal source and the second position signal can be assigned to the movable part; the control unit outputs a confirmation signal when both closure criteria are satisfied.

The present invention relates to the field of vehicle locking systems and relates to a method for detecting a closed position of a movable part of a vehicle according to the independent method claim, to a computer program product according to the further independent claim, and to a vehicle locking system according to the independent system claim.

Vehicle locking systems are generally used to securely lock and correspondingly unlock a movable part of a vehicle. These are therefore vehicle security systems that must function reliably to protect the occupants of the vehicle. According to the state of the art, it is usually queried via door contact switches whether a movable part of the vehicle is properly locked and/or closed. The signals of the door contact switch are, for example, converted into visual and/or acoustic information, so that an open and/or unlocked door can be identified. Furthermore, it is known that, as an alternative to the door contact switches, switches are integrated into corresponding vehicle locks of the movable parts. These query the position of the locking mechanism and then deliver a signal analogous to a door contact switch.

DE 10 2010 052 582 A1 discloses a method in which an open position of the door is detected by means of a door contact switch. If an occupant activates the electrically powered vehicle lock through an opening request, the door contact switch is queried, whereby it is detected whether the door has been opened.

DE 10 2016 202 975 A1 discloses a method for detecting a closed state that outputs a visual warning if the door of a vehicle is not locked, with a door contact switch on the B-pillar or on the door hinge delivering a corresponding signal.

A disadvantage of the state of the art is that the known systems can be manipulated using the simplest of means. For example, it is possible to intentionally or unintentionally actuate door contact switches from the outside, even though the door is not locked. Furthermore, the locking mechanism of a vehicle lock can be switched to the locked state from the outside, even though the door has not engaged in the lock holder. Thus, a locked door, which in reality is not locked at all, would be simulated for the vehicle.

This problem is of particular importance in the case of automatically operable vehicles, in particular in the case of vehicles operated without a driver.

The object of the invention is to at least partially eliminate the disadvantages known from the state of the art. In particular, the object of the present invention is to allow reliable detection of a closed door, thereby offering improved protection against manipulation.

The above object is achieved by a method having the features of the independent method claim, by a computer program product according to the corresponding independent claim, and by a system having the features of the independent system claim.

Further advantageous embodiments are specified in particular in the dependent claims and in the description. It should be pointed out that the features listed in the claims can be combined with one another in any technologically sensible manner and show further embodiments of the invention. Features and details that have been described in connection with the method according to the invention also apply, of course, in connection with the vehicle locking system according to the invention and/or the computer program product according to the invention and vice versa, so that the disclosure of the individual aspects of the invention is or can always be referred to alternately.

According to the invention, a method for detecting a closed position of a movable part of a vehicle, in particular an automatically operable vehicle, is proposed, the method comprising the following steps:
a control unit receives a first position signal from a first signal source as a first closure criterion which comprises at least one locking position of a vehicle lock for the movable part;
the control unit adds a conditional test instruction to the received first position signal, wherein the conditional test instruction comprises checking for at least one second position signal as a second closure criterion after detecting the first position signal, wherein the first closure criterion is also satisfied;
the control unit receives the second position signal from a second signal source as a second closure criterion, wherein the second signal source is different from the first signal source and the second position signal can be assigned to the movable part;
the control unit outputs a confirmation signal when both closure criteria are satisfied.

The method steps, processes, and operations described herein are not intended to necessarily be carried out in the particular order discussed or presented, unless indicated as an order in which they are to be carried out. The method steps can be executed at least partially simultaneously or chronologically one after the other, with the order of the method steps not being limited to the order defined by the numbering, so that individual steps can be carried out in a different order. It should also be understood that additional or alternative steps may be employed.

The invention thus essentially makes use of a multi-factor, in particular two-factor, query of position signals that differ from one another, with the signals originating from signal sources that differ from one another.

In a first step, a control unit receives a first position signal from a first signal source as a first closure criterion which comprises at least one locking position of a vehicle lock for the movable part. The locking position of the vehicle lock of or for the movable part is detected by a first signal source in the form of a position signal and interpreted as a first closure criterion for the movable part. According to the invention, the control unit can be a (superordinate) control unit of the vehicle, a lock control unit, or a server. In any case, the control unit is signal-connected (wireless and/or wired) to the first signal source.

In a further step, the control unit adds a conditional test instruction to the received first position signal, wherein the conditional test instruction comprises checking for at least one second position signal as a second closure criterion after detecting the first position signal, wherein the first closure criterion is also satisfied. The conditional test instruction thus serves to require at least one further closure criterion only when the first closure criterion is satisfied, i.e., when the locking position of the vehicle lock has been detected, with the first closure criterion still having to be satisfied. It is therefore not an OR operation of two signals but rather an AND operation. However, the first closure criterion must still be satisfied when the second closure criterion is queried/checked. An alternative query of the signal sources is thus prevented, so that, for example, a confirmation signal cannot be output by just a single position signal. Accordingly, the detection of the locking position in which the lock locks the movable part is always a first mandatory condition for the output of the confirmation signal.

In a further step, the control unit receives a second position signal from a second signal source as a second closure criterion, wherein the second signal source is different from the first signal source and the second position signal can be associated with the position, in particular the closed position, of the movable part. The second signal source is therefore a source that differs from the first signal source. This makes it at least more difficult to manipulate the signals. Even if the first signal source supplies a position signal which confirms the locking position of the lock, the second signal source is used to verify the first closure criterion, in which a further signal from another signal source is necessary. For example, the second position signal could be independent of the locking position of the vehicle lock. It is important according to the invention that the second position signal can also be associated with the movable part, in particular to the closed position of the movable part. It must therefore be possible to establish a relation to a position, in particular a closed position, of the movable part, so that a closed position of the movable part can be inferred. This can be, for example, the position of the movable part in relation to the body of the vehicle.

Only when the control unit receives the second position signal and the second closure criterion has thus been satisfied, is a confirmation signal generated/output by the control unit, whereby it is confirmed that the conditional test instruction has been satisfied. Satisfying both closure criteria is therefore absolutely mandatory for the output of the confirmation signal. According to the invention, the confirmation signal signals that the movable part of the vehicle is in the closed position. The confirmation signal can be an output signal, in particular an acoustic, visual, and/or haptic signal (vibration). The output signal can be used to prevent or limit other vehicle functions. For example, starting the engine, driving off, or accelerating can be influenced or trigger other restrictions that prevent or slow down the driving of the vehicle.

The invention thus has the advantage that a closed state of a movable part of the vehicle can be reliably detected. In addition, a failure or a fault in at least one of the signal sources can be detected.

Within the scope of the invention, a movable part can be a side door, sliding door, wing door, flap, tank flap, charging plug flap, tailgate, and/or a hood.

The control unit may have at least one computing unit for processing signals or data, at least one memory unit for storing signals or data, at least one interface to a signal source and/or an output unit for inputting position signals from the signal source or for outputting data or control signals to the output unit, and/or at least one communication interface for inputting or outputting data which are embedded in a communication protocol. The computing unit can be, for example, a signal processor, a microcontroller, or the like, wherein the memory unit can be a flash memory, an EEPROM, or a magnetic memory unit. The communication interface may be designed to input or output data wirelessly and/or by wire, wherein a communication interface that can input or output data by wire can input this data, for example, electronically or optically from a corresponding data transmission line or can output it into a corresponding data transmission line. In particular, it is conceivable for the control unit and/or computing unit to be arranged outside of the vehicle. It makes sense to use an IT infrastructure in the form of cloud computing or a similar network-based computer system. Such a solution can be advantageous, in particular, in the case of vehicles that can be operated in an automated manner, since remote maintenance or remote control and monitoring is made possible. The risk of manipulation on/in the vehicle can be reduced.

The control unit can be designed to execute a diagnostic routine. This makes it possible to check whether the signal source(s) is/are in an operational state or whether there are malfunctions. Depending on a diagnostic routine, it is possible to recalibrate the system if necessary, to reset system parameters, or to display any errors so that maintenance is possible. As such, it is conceivable that the associated measured values of a predetermined position, preferably the main ratchet position, are stored and compared with one another, so that deviations can be detected and conclusions can be drawn about possible malfunctions. During the product life cycle, changes, in particular caused by wear and tear or external environmental influences, can be detected and included in the position determination. This increases the reliability of the position detection.

It can be advantageous for the control unit to output an error signal if the first and/or second closure criterion is violated. If the first and/or second signal source does not send a position signal or if the control unit does not receive such a signal, the error signal indicates that the closed position of the movable part is not present, i.e., it could not be verified/ensured. Accordingly, not only can it be positively determined that the movable part is in the closed position, but it can also be positively determined that the movable part is not in the closed position. Furthermore, it is conceivable that the error signal makes it possible to determine the existing error source, i.e., which signal source is not supplying a position signal. Possible manipulations can thus be determined, for example, or unintentional disruptive influences can be detected, which further increases reliability.

Within the scope of the invention, the control unit can determine a time interval between the first position signal and the second position signal as a first time criterion and compare it with a fixed second time criterion, preferably stored in the control unit, and if the second time criterion is violated (deviates from) the first time criterion, the control unit outputs a corresponding error signal. As a result, the reliability can also be increased further as a result. The time check can be part of the conditional test instruction. This means that the time criteria are checked for satisfaction within the conditional test instruction. A different, in particular too long, time interval between the two position signals can indicate manipulation or an error.

According to the invention, it is conceivable that the first signal source is a locking mechanism sensor, in particular a pawl sensor, of the vehicle lock, with a locking position preferably being detected and the pawl blocking a catch of the vehicle lock in the locking position. A locking mechanism sensor according to the invention can be, for example, sensors that work inductively, capacitively, magnetically, or optically. In addition, microswitches or Hall sensors can, in particular, be used to detect the position of the locking mechanism, in particular a locking position. The locking position can preferably be a pre-ratchet and/or main ratchet position of the locking mechanism. Assuming a locking position, in particular the pre-ratchet and/or main ratchet position, makes it possible to determine whether a lock holder of the movable part has engaged in the locking mechanism of the vehicle lock so that a first closure criterion is represented by the pre-ratchet or main ratchet position.

It is also conceivable that the second signal source is a contact switch, in particular a contact switch that is not accessible from the outside, of the movable part. The contact switch is preferably a door contact switch, with the door contact switch detecting a closed position of the door. Contact switches of this type are regularly arranged in the region of the mounting or suspension of the movable part or on the side opposite the mounting, on which side the vehicle lock is usually located. According to the invention, it is particularly advantageous if the contact switch is not accessible to a person, so that manipulation to that effect can at least be made more difficult or prevented. For this purpose, a contact switch according to the invention can be arranged, for example, in the region of the door mounting/door suspension and be at least partially covered by parts of the vehicle body. Particularly preferably, a plurality of contact switches can be arranged at different locations on the movable part, so that incorrect actuation or intentional manipulative actuation is at least made more difficult.

It can be advantageous if the first or the second signal source is a closing aid for the vehicle lock and/or a drive for the movable part. A closing aid according to the invention serves to allow the locking mechanism of the vehicle lock to be transferred from the pre-ratchet to the main ratchet position. For this purpose, the closing aid can in particular be operatively connected to a catch or interact with it, so that it can be rotated about its axis of rotation in the direction of the main ratchet. A drive according to the invention for the movable part can, for example, but not exclusively, be designed as a door and/or tailgate drive and convert the movable part, preferably a door, from an open position to a closed position or vice versa. In addition, a drive for the movable part can also be understood as a positioner for the movable part, with the positioner being able to move the movable part at least from a closed position to a partially open position and/or vice versa. A drive according to the invention and/or a positioner according to the invention regularly have position sensors that make it possible to determine the position of the movable part.

Within the scope of the invention, the second signal source can be a lock holder sensor. A lock holder sensor according to the invention detects whether the movable part is in the closed position, in particular in the locked position, and thus forms a reliable second position signal. It is particularly preferred if the lock holder sensor is arranged on the movable part or the vehicle so that it is inaccessible from the outside for people or disturbing environmental influences. As a result, intentional or unintentional manipulation can be further reduced, as a result of which reliability and thus security can be further increased.

According to the invention, it is conceivable that the second signal source is a force sensor for detecting a sealing pressure of the movable part. In this case, the force sensor detects the pressure on the seal, in particular in the form of a door seal pressure, the pressure being generated by a closed state of the movable part. The seal may be arranged on the movable part or the vehicle. The force sensor is arranged on and/or at least partially in the seal. The force sensor may be arranged only selectively or over the entire circumference on/in the seal. The force sensor can thus detect the closed position of the movable part and thus supply a second position signal that can be reliably used as a second closure criterion. It is particularly advantageous in this case that the force sensor is essentially protected from disruptive environmental influences, as a result of which the reliability can be increased and the probability of failure can be reduced.

It is conceivable that the second signal source is an image acquisition unit of the vehicle, with the image acquisition unit detecting a position of the movable part. The image acquisition unit can be arranged on and/or in the vehicle, for example on a tailgate or a rear-view mirror. In particular, the image acquisition unit can form part of the rear-view mirror. The image acquisition unit can be designed as a camera, for example, and capture the movable part at least in portions, so that at least one closed position of the movable part can be detected. It is particularly advantageous in this case that a closed position is not possible by manipulating the image acquisition unit from the outside. A correspondingly reliable second signal source is provided, by means of which the closed position of the movable part can be detected.

It can be advantageous if the second signal source is a displacement sensor for the movable part, with the displacement sensor measuring a distance between the movable part and the vehicle. The displacement sensor can, for example, be arranged in a hinge of the movable part or in the movable part itself. The sensor measures a distance between the movable part and the vehicle, in particular a position or a distance covered after the movable part has moved. Thus, the position, in particular the closed position, of the movable part can be concluded, so that a reliable second closure criterion is provided.

Within the scope of the invention, a secure transmission channel with end-to-end encryption can be established/exist between the control unit and at least the first signal source and/or the second signal source. A secure transmission channel with end-to-end encryption makes it possible to reduce manipulation, so that reliability can be increased.

According to another aspect of the invention, a computer program product is claimed. The computer program product according to the invention comprises executable program code, the program code executing the method according to the invention when executed by a data processing device. The program code is preferably stored on a machine-readable medium or storage medium such as a semiconductor memory, a hard disk memory, or an optical memory and is used to carry out, implement, and/or control the steps of the method according to the invention, with the program product or computer program in particular being stored on a computer or a device, for example a control unit.

According to another aspect of the invention, what is claimed is a machine-readable medium storing the computer program product as claimed.

Another aspect of the invention claims a vehicle locking system for detecting a closed position of a movable part of a vehicle, comprising a vehicle lock for locking the movable part to the vehicle, wherein the vehicle lock can be mounted on the movable part or on the vehicle, and the vehicle lock has at least one locking mechanism sensor as a first signal source for detecting at least one first position signal, in particular in the form of a locking position of the locking mechanism; a second signal source that is different from the first signal source and detects a second position signal that can be associated with the movable part; further comprising a data processing device, in particular in the form of a control unit, with a non-volatile computer-readable storage medium on which the computer program product according to the invention is stored, wherein the data processing device is at least designed to execute the program code of the computer program product.

The second signal source is preferably designed such as is claimed in at least one of the dependent claims of the method according to the invention and/or is described in relation thereto.

Further measures improving the invention emerge from the following description of some exemplary embodiments of the invention, which are shown schematically in the figures. All of the features and/or advantages resulting from the claims, the description, or the drawing, including structural details, spatial arrangements, and method steps, may be essential to the invention both on their own and in the most varied of combinations. It should be noted that the figures are only of a descriptive character and are not intended to restrict the invention in any way.

In the drawings:

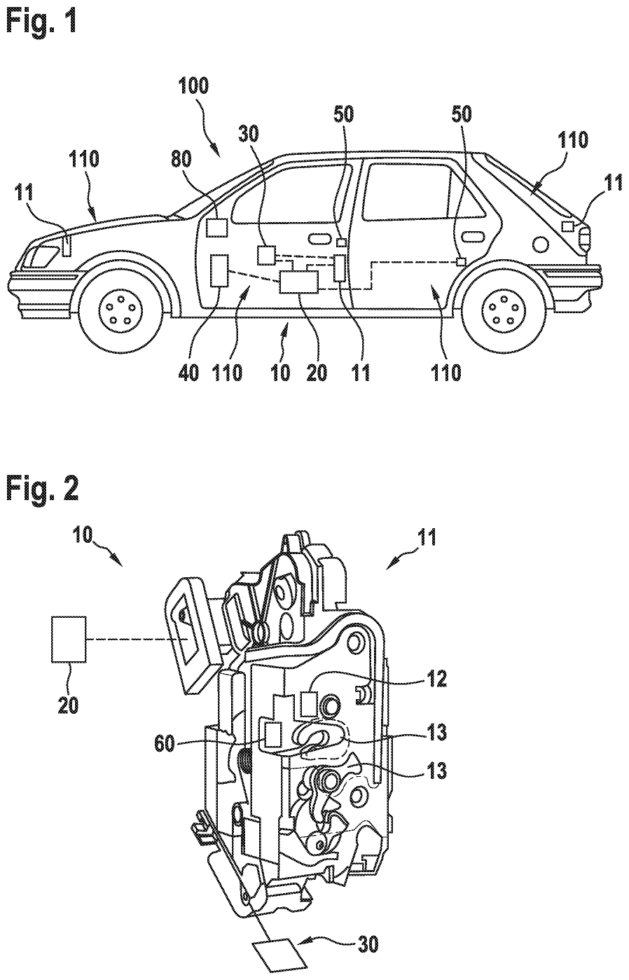

FIG. 1 schematically shows a vehicle with an exemplary embodiment of a vehicle locking system according to the invention and

FIG. 2 shows a possible exemplary embodiment of a vehicle locking system according to the invention.

FIG. 1 shows a vehicle having a vehicle locking system according to the invention for movable parts 110 of the vehicle 100. The movable parts 110 of the vehicle 100 are schematically shown in FIG. 1 as a tailgate 110, a hood 110, and side doors 110. A vehicle locking system 10 according to the invention may be associated with each of these movable parts 110. For this purpose, the movable part 110 may have a vehicle lock 11 which is used to lock the movable part 110 on the vehicle 100. Accordingly, within the scope of the invention, a vehicle lock 11 can be designed as a side door lock, a tailgate lock, and/or a hood lock. The side door of FIG. 1 thus has a vehicle lock 11, the vehicle lock 11 being signal-connected to a control unit 20 and a closing aid 30. According to the invention, the closing aid 30 serves in particular to move the locking mechanism of the vehicle lock 11 from a pre-ratchet position into a main ratchet position. The closing aid 30 can be provided according to the invention as a second signal source. A second position signal can be detected via the closing aid 30, with the closing aid 30 generating a second position signal upon reaching the main ratchet position, which reflects the locked and thus closed position of the movable part 110, in this case the side door. In addition to a locking mechanism sensor of the vehicle lock 11, the second position signal supplied by the closing aid 30 can be used together with the first position signal of the locking mechanism sensor of the vehicle lock 11 to conclude a closed position of the movable part, i.e., in this case the side door 110. By way of example, the control unit 20 is arranged in the side door 110 in this case. According to the invention, however, the control unit 20 can be arranged at any location in the vehicle. This can be a control unit of the motor vehicle lock 11 or a control unit superordinate to the vehicle.

Furthermore, FIG. 1 shows a drive 40 for opening and/or closing the movable part 110. A door drive 40 of this type is already sufficiently known from the state of the art. The drive 40 can move the movable part at least into an open or closed position. At the same time, a position of the movable part can be determined via the drive 40. A position sensor can be provided within the drive 40 for this purpose. The drive 40 for opening and/or closing the movable part 110 is also signal-connected to the control unit 20.

A contact switch 50 on the two side doors 110 of the vehicle 100 is also shown in FIG. 1 as an example. Contact switches 50 according to the invention can be used as a second position signal source, with a contact switch 50 being contacted by the movable part 110 in its closed position, so that a closed position of the movable part 110, in this case the side door, can be ensured. According to the invention, the contact switch 50 is advantageously arranged on the movable part 110 or the vehicle body of the vehicle 100 such that manipulation from the outside is at least more difficult. For this purpose, the contact switch 50 is preferably arranged outside of a user's area of accessibility. At the same time, the contact switch 50 is designed such that actuation is preferably triggered only in a closed position of the movable part. This ensures that the second position signal is only generated by the contact switch 50 when the vehicle door 110 is closed. According to the invention, the contact switch 50 is also signal-connected to the control unit 20, which is indicated herein by the dashed line.

Furthermore, an image acquisition unit 80 is shown in FIG. 1, by which a second position signal can be detected, wherein the image acquisition unit 80 can detect a position of the movable part 110. In particular, the image acquisition unit 80 is designed such that at least one closed position of the movable part 110 can be determined by the image acquisition unit 80. A closed position of the movable part 110 can thus be generated as a second position signal for verifying the closed position of the movable part 110 by means of the image acquisition unit 80. According to the invention, the image acquisition unit 80 is also signal-connected to the control unit 20 so that a second position signal can be transmitted from the image acquisition unit 80 to the control unit 20.

FIG. 2 shows an exemplary embodiment of a vehicle locking system 10 according to the invention. The vehicle locking system consists of a vehicle lock 11, the vehicle lock 11 having a locking mechanism 13 and the locking mechanism 13 consisting of at least one catch and at least one pawl. A locking mechanism sensor 12 is associated with the locking mechanism 13, with, in particular, a locking position of the locking mechanism 13 being detectable by means of the locking mechanism sensor 12. The locking mechanism 13 serves to lock a movable part of the vehicle, in particular a side door, a tailgate door, or a hood or sliding door, to the vehicle/vehicle body. A locking state thus corresponds to a closed position of the movable part, with the locking mechanism additionally securing the closed position of the movable part. For this purpose, the locking mechanism, in particular the catch of the locking mechanism, is in holding engagement with a lock holder, the lock holder preferably being arranged on the body of the vehicle. However, it is also conceivable that a vehicle lock 11 is arranged in the vehicle or the vehicle body and the lock holder is accordingly located on the movable part. This is realized, for example, with a hood lock.

The vehicle lock 11 is signal-connected to the control unit 20, the data connections being shown herein with a dashed line. Furthermore, a lock holder sensor is associated with the vehicle lock 11 in FIG. 2, wherein a lock holder sensor according to the invention is arranged on the vehicle lock 11 such that a position of the lock holder in the vehicle lock 11 can be detected. In particular, the lock holder sensor 60 can detect a position of the lock holder, which corresponds to a locking position of the lock holder with the locking mechanism 13. Accordingly, the lock holder sensor 60 and the locking mechanism sensor 12 deliver the two position signals which are sent to the data processing device.

Furthermore, FIG. 2 shows a closing aid 30, which is in operative connection with the vehicle lock 11, in particular the locking mechanism 13. The closing aid 30 can thus be used to transfer the locking mechanism from a pre-ratchet position to a main ratchet position. It is also conceivable that the closing aid 30 uses a third position signal to verify the closed position of the movable part. Accordingly, at least three position signals can be used by the control unit 20 to verify a closed position of a movable part.

### LIST OF REFERENCE SIGNS

10 Vehicle locking system
11 Vehicle lock
12 Locking mechanism sensor
13 Locking mechanism
20 Control unit/data processing device
30 Closing aid
40 Drive
50 Contact switch
60 Lock holder sensor
70 Force sensor
80 Image acquisition unit
90 Displacement sensor
100 Vehicle
110 Movable part

1. A method for detecting a closed position of a movable part of a vehicle comprising the steps of:
a control unit receives a first position signal from a first signal source as a first closure criterion which comprises at least one locking position of a vehicle lock for the movable part;
the control unit adds a conditional test instruction to the received first position signal, wherein the conditional test instruction comprises checking for at least one second position signal as a second closure criterion after detecting the first position signal, wherein the first closure criterion is also satisfied;
the control unit receives the second position signal from a second signal source as the second closure criterion, wherein the second signal source is different from the first signal source and the second position signal is assigned to the movable part; and
the control unit outputs a confirmation signal when both the first closure criterion and the second closure criterion are satisfied.

2. The method according to claim 1, wherein the control unit outputs an error signal if at least one of the first or second closure criterion is violated.

3. The method according to claim 1, wherein the control unit determines a time interval between the first position signal and the second position signal as a first time criterion and compares the first time criterion with a fixed second time criterion stored in the control unit, and if first time criterion violates the second time criterion, the control unit outputs an error signal.

4. The method according to claim 1, wherein the first signal source is a pawl sensor for a pawl of the vehicle lock, with a locking position being detected of the pawl blocking a catch of the vehicle lock in the locking position.

5. The method according to claim 1, wherein the second signal source is a contact switch which is not accessible from the outside of the movable part.

6. The method according to claim 1, wherein the first or the second signal source is at least one of a closing aid of the vehicle lock or a drive for the movable part.

7. The method according to claim 1, wherein the second signal source is a lock holder sensor.

8. The method according to claim 1, wherein the second signal source is a force sensor for detecting a sealing pressure of the movable part.

9. The method according to claim 1, wherein the second signal source is an image acquisition unit of the vehicle, the image acquisition unit detecting a position of the movable part.

10. The method according to claim 1, wherein at least one of the first and the second signal source is a displacement sensor of the movable part, the displacement sensor measuring a distance that the movable part has moved.

11. (canceled)

12. A non-transitory computer readable medium comprising executable program code, wherein the program code, when executed by a control unit, executes the method according to claim 1.

13. A vehicle locking system for detecting a closed position of a movable part of a vehicle, comprising:
a vehicle lock for locking the movable part to the vehicle, wherein the vehicle lock is mounted on the movable part or on the vehicle, and the vehicle lock has at least one locking mechanism sensor as a first signal source for detecting at least one first position signal corresponding to a locking position of the locking mechanism;
a second signal source that is different from the first signal source and that detects a second position signal that is associated with the movable part; and
a control unit comprising, the non-transitory computer-readable medium according to claim 12, wherein the control unit is configured to execute the program code stored on the non-transitory computer-readable medium.

14. The vehicle locking system according to claim 13, wherein the locking mechanism sensor is a pawl sensor.

15. The vehicle locking system according to claim 13, wherein the second signal source is arranged in or on the vehicle lock.

16. The vehicle locking system according to claim 13, wherein the second signal source is at least one of a closing aid of the vehicle lock and as a drive for the movable part.

17. The vehicle locking system according to claim 13, wherein the second signal source is a contact switch of the movable part.

18. The vehicle locking system according to claim 13, wherein the second signal source is a lock holder sensor.

19. The vehicle locking system according to claim 13, wherein the second signal source is a force sensor for detecting a sealing pressure of the movable part.

20. The vehicle locking system according to claim 13, wherein the second signal source is an image acquisition unit of the vehicle, with at least one position of the movable part being detected by the image acquisition unit.

21. The vehicle locking system according to claim 13, wherein the second signal source is a displacement sensor of the movable part, wherein a distance that the movable part has moved is measured by the displacement sensor.
